(19) United States
(12) Patent Application Publication
(10) Pub. No.: US 2015/0149044 A1
(43) Pub. Date: May 28, 2015

(54) SYSTEM AND METHOD FOR CONTROLLING VEHICULAR REAR VISION

(71) Applicant: Wistron Corp., New Taipei City (TW)

(72) Inventors: Meng-Kai LIN, New Taipei City (TW); Chia-Liang LAI, New Taipei City (TW)

(73) Assignee: Wistron Corp., New Taipei City (TW)

(21) Appl. No.: 14/261,163

(22) Filed: Apr. 24, 2014

(30) Foreign Application Priority Data
Nov. 27, 2013 (TW) 102143257

(51) Int. Cl. B60R 1/02

(52) U.S. Cl. CPC B60R 1/025
USPC 701/49

(57) ABSTRACT

Disclosed herein are a system and a method for controlling a rear vision assembly (RVA) of a vehicle, the system comprising a sender, receivers, an orientation device, a controller, and a motor. At least one said receiver disposed at the RVA may receive a reference signal from the sender to generate a relative positioning signal. The orientation device, disposed at the RVA, senses the orientation thereof in the three-dimensional space. Based on the relative positioning signal, the controller determines a relative position of the RVA and the sender and compares it with a default relative position, in addition to comparing the sensed orientation with a default orientation, thus generating a driving signal that directs the motor to restore the RVA to its default configuration when the determined relative position has deviated from the default for a predefined time and the sensed orientation deviates from the default.

### CROSS-REFERENCE TO RELATED APPLICATIONS

This non-provisional application claims priority under 35 U.S.C. §119(a) on Patent Application No. 102143257 filed in Taiwan, R.O.C. on Nov. 27, 2013, the entire contents of which are hereby incorporated by reference.

### TECHNICAL FIELD

The present disclosure relates to the provision of rear vision to a vehicular driver, particularly to a system and a method for automatically maintaining the default configuration of a rear vision assembly.

### BACKGROUND

In a vehicle, a rear-view mirror, if any, shows the driver what is (approximately) behind him/her, whereas a side-view or wing mirror reflects the exterior side to which it is attached. Despite the gradual prevalence of reverse radars and rear cameras in the vehicular market, rear- and side-view mirrors, for their simplicity, remain over the years the most familiar and dependable standard safety equipment to drivers.

Adjusting a rear- or side-view mirror, especially its orientation, depends on the build, habits, and driving pose of the vehicular operator as an observer. A mirror misconfigured obviously fails to display a proper view of the rear. A mirror affixed to the outside of the vehicle, however, protrudes from and usually forms the widest part of the vehicle. It is not uncommon then that on the road such a mirror is bent or damaged due to collision with another vehicle, or due to the inertial difference between the vehicular body and the mirror induced by rough or neglected pavement. Even an interior mirror is likely to divert from the preferred configuration because of the movements of the driver or passengers in a limited space. The most recommended course to restore the mirror to its default is for the driver to pull over and adjust it manually. Nevertheless, drivers are reluctant or unable to halt their trip, and as a result often jeopardize themselves distractedly making adjustments.

### SUMMARY

In light of the above, the present disclosure provides a system and a method for controlling a rear vision assembly of a vehicle. The rear vision assembly, usually a rear- or side-view mirror, includes a reflecting component or a set thereof along with the likes of a frame, shaft, stand, or pedestal for support, extension, enclosure, etc.

The system for controlling vehicular rear vision, as provided by this disclosure, comprises a sending device, a plurality of receiving devices, an orientation device, a control device, and a motor. The receiving devices, the orientation device, and the motor are disposed at the rear vision assembly. The sending device is adapted for sending a reference signal. The receiving devices are adapted for receiving the reference signal to generate a relative positioning signal. The orientation device is adapted for sensing an orientation of the rear vision assembly in the three-dimensional space. The control device is adapted for determining a first relative position of the rear vision assembly and the sending device based on the relative positioning signal. The control device compares the first relative position with a default relative position and compares the orientation with a default orientation, in order to generate a driving signal, whereby the motor adjusts the rear vision assembly. In particular, the driving signal is adapted for directing the motor to restore the rear vision assembly to the default relative position and orientation when the determined first relative position has deviated from the default for a predefined time and the sensed orientation is also different from the default.

In the method for controlling vehicular rear vision, as provided by this disclosure, a reference signal from a sending device is received to generate a relative positioning signal, based on which a first relative position of the rear vision assembly and the sending device is determined. Meanwhile, an orientation of the rear vision assembly in the three-dimensional space is sensed. The rear vision assembly is adjusted to a default relative position and a default orientation when the determined first relative position has deviated from the default for a predefined time and the sensed orientation is also different from the default.

In short, the default configuration of the rear vision assembly is memorized in the system and method of the present disclosure and automatically restored to when it is discovered that the assembly has gone askew. Road conditions vary, hence multiple factors, including a reference object (the sending device), its relative position to the assembly, the predefined time, and the conditional driving signal, are considered to avoid misjudgment. Furthermore, in some embodiments, the rear vision assembly is actively adjusted to provide a more useful view, based on the direction to which the vehicle turns.

### BRIEF DESCRIPTION OF THE DRAWING

The present disclosure will become more fully understood from the detailed description given hereinbelow and the accompanying drawings which are given by way of illustration only and thus are not limitative of the present disclosure and wherein:

FIG. 1 illustrates the disposition of a sending device and receiving devices, in accordance with an embodiment of the present disclosure.

FIG. 2 is a high-level block diagram of a system for controlling vehicular rear vision, in accordance with an embodiment of the present disclosure.

FIG. 3 illustrates the disposition of a sending device, a setup button, and receiving devices, in accordance with an embodiment of the present disclosure.

FIGS. 4, 5, and 6 are flowcharts of methods for controlling vehicular rear vision, in accordance with various embodiments of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

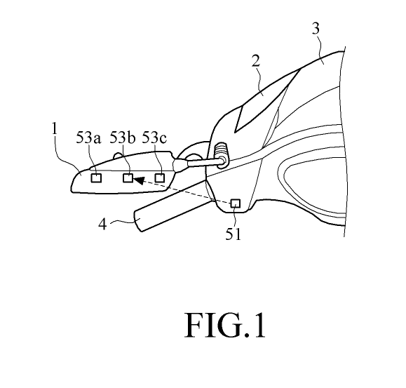

Please refer to FIG. 1, which shows in part a steering head of a motorcycle. The steering head may include a directional indicator 2, a headlamp 3, a handlebar 4, and most importantly a rear vision assembly (RVA) 1 serving as a wing mirror. The receiving devices 53a, 53b, and 53c (three of them as an example) of a system of the present disclosure may be mounted on top of the RVA 1 and adapted for receiving a wireless reference signal from a sending device 51. The reference signal may be an infrared one; as such, on the steering head the sending device 51 needs to be disposed at a place other than the RVA 1 and where line-of-sight propagation of the signal to the receiving devices is not obstructed. For instance, in FIG. 1, the sending device 51 is located near where the dials usually are, the dashed arrow signifying the path of propagation of the reference signal. Since it is the receiving device 53b that happens to be on the path and receives the signal (or detects the strongest level of the signal among the three), the direction of the reference signal falls close to the center line of the RVA 1 by default. If the receiving device 53a on the outside received the signal instead, then the RVA 1 might have been bent counterclockwise when viewed from the top. If the signal levels at both receiving devices 53b and 53c were roughly equal, then a slight clockwise tilt of the RVA 1 toward the front of the vehicle could be deduced. If the reference signal was not detected by any of the receiving devices, the RVA 1 might be severely bent, or there was a malfunction within the system. The present disclosure does not prescribe the exact number and locations of the receiving devices, other than that they must be disposed at the RVA 1. Beyond the line-of-sight requirement, the sending device 51 may also be placed anywhere with a fixed relative position to the RVA 1, barring the effects of an unforeseeable external force, if installed on a motorcycle or any other vehicle.

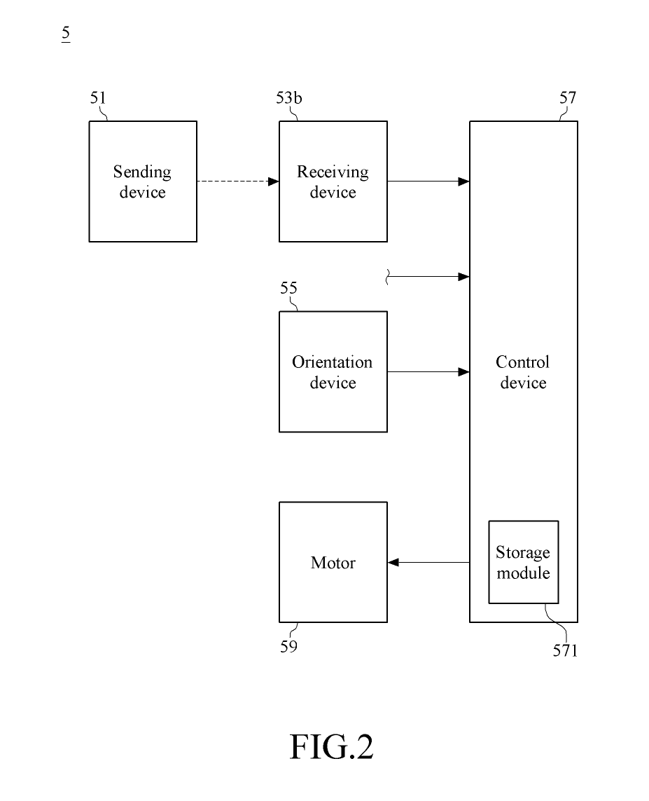

Please refer to FIG. 2 with regard to FIG. 1. As shown in the block diagram of the system 5, the receiving device 53b picking up the reference signal generates a relative positioning signal for the control device 57, while the break line represents the other receiving devices. The control device 57 determines the relative position of the sending device 51 and the RVA 1 based on the signal generated by one or more of the receiving devices, as described in the previous paragraph. The orientation device 55, mounted on or embedded in the RVA 1, may be a gyroscope adapted for sensing and reporting to the control device 57 the current orientation of the RVA 1 in the three-dimensional space. The control device 57, disposed at the vehicle (inside or outside the RVA 1), comprises a storage module 571 along with a microcontroller, a processor, or a comparator. The storage module 571, which may include a flash memory or other types of electrically erasable programmable read-only memory (EEPROM), records a default relative position of the

RVA 1 and the sending device 51, and a default orientation of the RVA 1 in the three-dimensional space. The default relative position and orientation may be factory-programmed or configured by the operator of the vehicle. When the relative position determined by the control device 57 disagrees with the default relative position, and the default orientation does not match the current orientation sensed by the orientation device 55, the RVA 1 is deemed to be at a slant, and under certain conditions (detailed later) the control device 57 drives the motor 59 to adjust the frame, stand, or the reflecting component (set) of the RVA 1 in order to restore it to its default configuration.

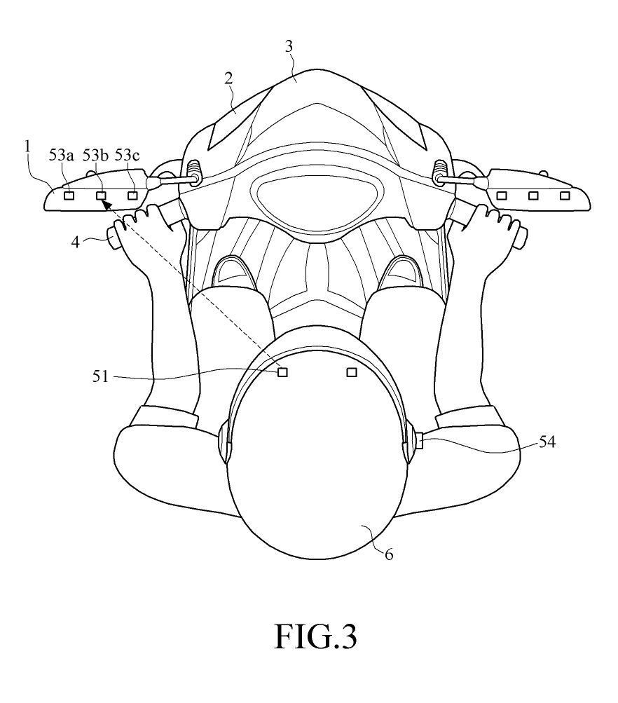

Please refer to FIG. 3, which depicts a symmetric pair of systems for controlling vehicular rear vision in another embodiment. The sending device 51 in this case is not affixed to the steering head or the body of the motorcycle, but to a wearable accessory of the rider, e.g. the helmet 6, for simulating the rider's line of sight when observing the RVA 1. The operator of a travelling vehicle constantly moves his/her head around to keep an eye on road conditions, changing the relative position of the sending device 51 and the RVA 1 frequently. Though unpredictable, this is not out of the ordinary. Upon detecting that the current and default relative positions disagree, therefore, the control device 57 must consider also whether the disagreement has been, say, for a predefined time. Only when the disagreement is confirmed to be persistent does the control device 57 make subsequent decisions or drive the motor 59.

Please note that in FIG. 3 and on the helmet 6 there is also a setup button 54 for assisting the control device 57 in recording the default relative position and orientation. Before setting off, the rider may adjust the length, angle, etc of the frame, stand, or reflecting component of the RVA 1 to an ideal configuration, look toward the normal travelling direction of the vehicle, and press the setup button 54 to write the instantaneous orientation of the RVA 1 and relative position of the sending device 51 and the RVA 1 (equivalent to the rider's line of sight) into the storage module 571. The setup button 54 does not have to be on the helmet 6, and is merely an example of a setup mechanism. On the vehicle the setup button 54 may be disposed anywhere readily accessible to the operator maintaining a regular posture, such as beside the dials, on the RVA 1, or on the sending device 51. A setup mechanism not incorporating the setup button 54 may, for instance, employ gestures associated with the sending device 51 and one or more receiving devices. As an example, the rider may rhythmically block or let through the propagation of the reference signal with her hand after a relative position is established between the sending device 51 and the receiving device 53b, influencing the generated relative positioning signal, whereby the control device 57 commences writing into the storage module 571.

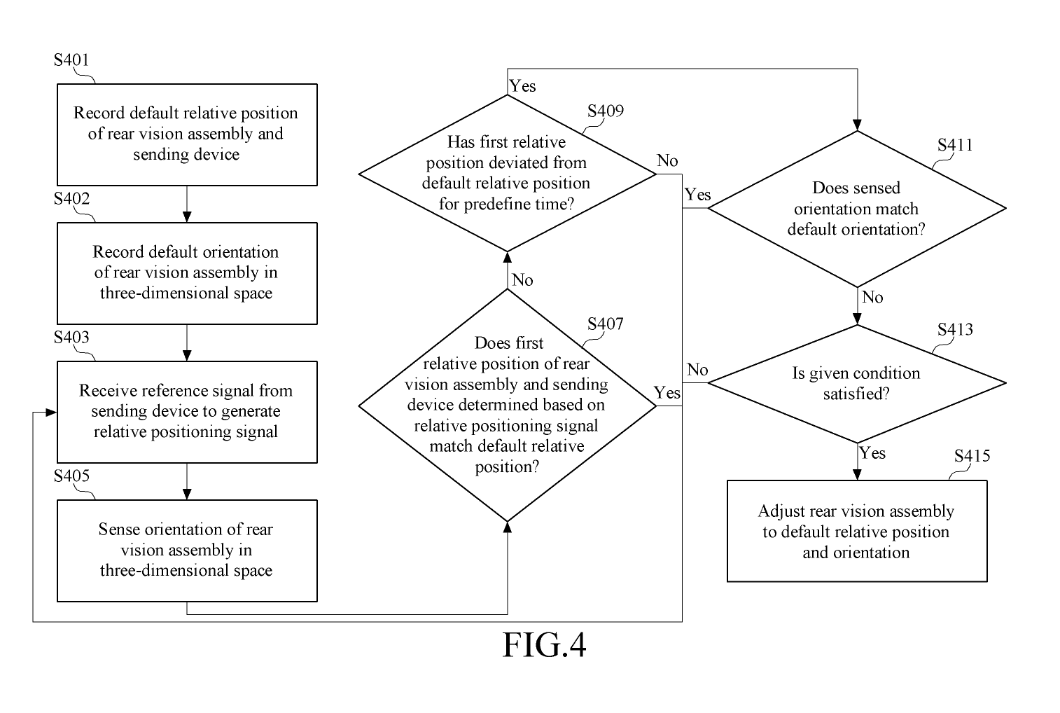

Please refer to FIG. 4 with regard to FIG. 2. As shown in the flowchart, in step 5401 the storage module 571 records a default relative position of the RVA 1 and the sending device 51. In step S402, the storage module 571 records a default orientation of the RVA 1 in the three-dimensional space. One or more of the receiving devices 53a, 53b, and 53c receives the reference signal from the sending device 51 to generate the relative positioning signal in step S403. In step S405, the orientation device 55 senses an orientation of the RVA 1 in the three-dimensional space. Please note that steps S403 and S405 are not necessarily carried out in that order and together they represent a monitoring mode of the system 5. The control device 57 determines, based on the relative positioning signal, a first relative position of the present between the RVA 1 and the sending device 51, and determines in step S407 whether the first relative position matches the default. If it does, monitoring continues in step S403 or S405; if not, step S409 is executed. In step S409, the control device 57 determines whether the first relative position has deviated from the default for a predefined time. If so, step S411 is executed; if the predefine time has not yet expired, the flow returns to step S403 or S405. In step S411, the control device 57 determines whether the current orientation of the RVA 1 agrees with the default. If it does, step S403 or S405 is performed; if not, the motor 59 is driven to adjust the RVA 1 in step S415. In one embodiment, before step S415 the control device 57 further determines whether a given condition is satisfied in step S413. If it is, step S415 is carried out, otherwise step S403 or S405 is resumed. Step S413 aims at reaffirming that the RVA 1 requires adjustment because it is abnormally bent and not that the RVA 1 is oriented and positioned differently as a result of the vehicle turning. (There is no way to predict how a driver would turn her head when she goes around a corner.) The condition may be a command from the vehicular operator similar to the gestures mentioned above, such as the motorcyclist turning head, temporarily making the receiving device 53c the one receiving the reference signal instead of the receiving device 53a, which may have been picking up the signal since the RVA 1 went askew.

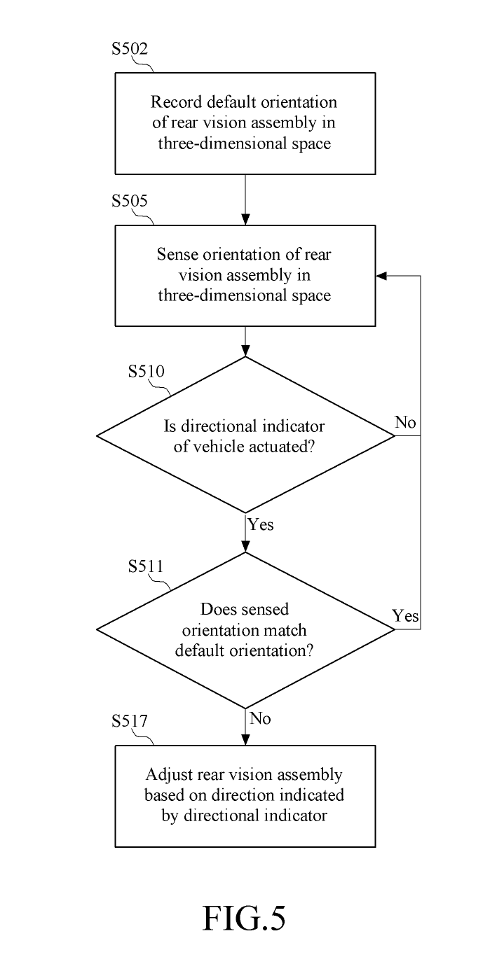

The system and method of the present disclosure are also capable of actively adjusting a RVA on a cornering vehicle to provide a more useful view to the operator. Generally, this means extending the RVA outwards (counterclockwise when turning right and clockwise when turning left, viewed from the top) so that it reflects the road conditions at the back of the car opposite the original travelling direction. Please refer to FIG. 5 with regard to FIGS. 1, 2, and 4 for an illustration, and assume that in this embodiment the sending device 51 is disposed at the vehicle and the control device 57 is coupled with the vehicle's directional indicator 2 indicating left turns. The steps not related to the active adjustment are omitted in FIG. 5, where step S502 is equivalent to step S402 in FIG. 4, S505 is to S405, and S511 to S411. After step S505, the control device 57 determines in step S510 whether the switch of the directional indicator 2 is flipped so that it is actuated (and flashing). If so, step S511 is executed; if not, monitoring continues in step S505. If in step S511 the control device 57 determines that the current orientation sensed by the orientation device 55 disagrees with the default one (signifying that the vehicle is turning, in accordance with the actuation of the directional indicator 2), the RVA 1 is adjusted in step S517 based on the direction indicated.

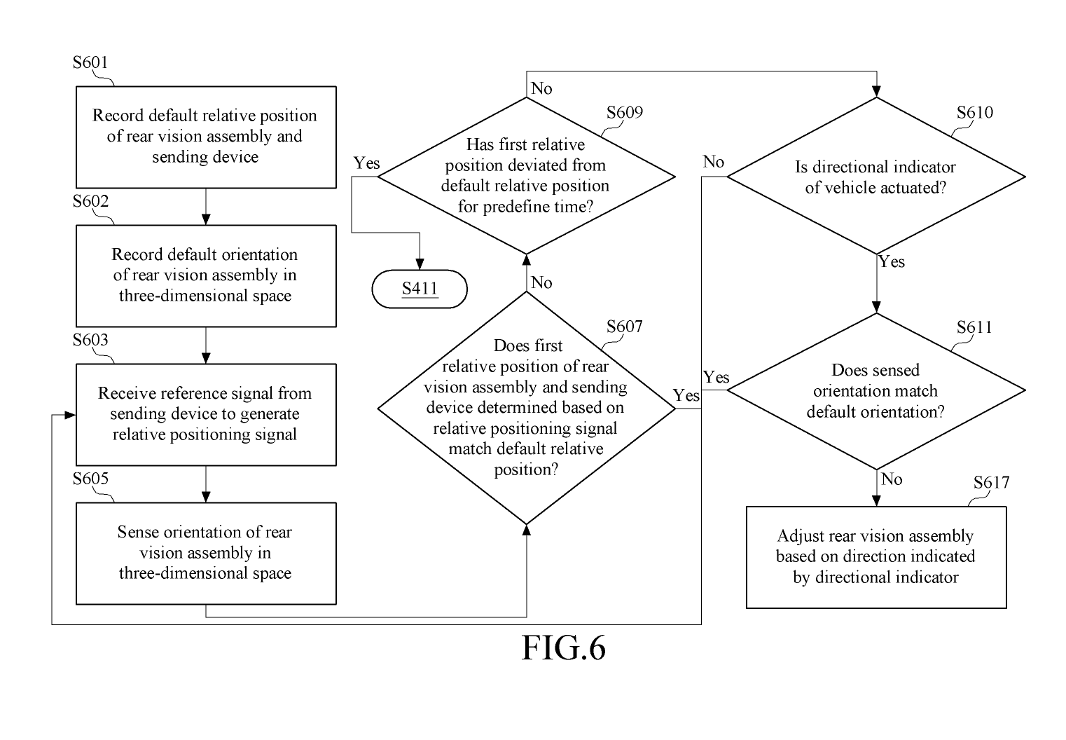

Alternatively, assume that the sending device 51 is not disposed at the vehicle, then naturally the relative position of the RVA 1 and the sending device 51 changes when the vehicle corners. Please refer to FIG. 6 with regard to FIGS. 2, 4, and 5 for an illustration of the active adjustment with the relative position accounted for. In FIG. 6, steps S601, S603, S607, and S609 correspond to FIG. 4 steps S401, S403, S407, and S409, respectively; step S602 is equivalent to step S402 or step S502 in FIG. 5, as step S605 is to step S405 or S505, and step S611 is to step S411 or S511; steps S610 and S617 respectively correspond to steps S510 and S517. FIGS. 6 and 4 depict different functions that may coexist in the system 5, the difference being primarily that if it is determined in step S609 that the first relative position has not yet deviated from the default for the predefined time, then the control device 57 deduces that the vehicle may simply be turning at the moment. Similar to FIG. 5, the control device 57, concluding with steps S610 and S611, proceeds with step S617 to adjust the RVA 1. If the first relative position has deviated long enough, the procedure in FIG. 4 is followed to confirm whether the RVA 1 is abnormally bent.

To summarize, the system and method of the present disclosure can be integrated with a vehicle such as an automobile or a motorcycle to memorize the default configuration of a RVA and automatically recover it when it has gone awry. The sending device included may be wearable or mounted. The system and method may further incorporate a setup mechanism, e.g. a setup button, for the default configuration. Road conditions vary; hence multiple factors are recognized to avoid misjudgment. The factors include whether the first relative position matches the default, whether the mismatch has lasted for a predefined time, whether the current and default orientations of the RVA agree, and whether a given condition is satisfied. Furthermore, in some embodiments, the rear vision assembly is actively adjusted to enhance safety, based on the direction to which the vehicle turns.

What is claimed is:

1. A system for controlling a rear vision assembly of a vehicle, comprising:
a sending device for sending a reference signal;
a plurality of receiving devices disposed at the rear vision assembly and for receiving the reference signal to generate a relative positioning signal;
an orientation device disposed at the rear vision assembly and for sensing an orientation of the rear vision assembly in the three-dimensional space;
a control device for determining a first relative position of the rear vision assembly and the sending device based on the relative positioning signal, and for comparing the first relative position with a default relative position and comparing the orientation with a default orientation to generate a driving signal; and
a motor disposed at the rear vision assembly and for adjusting the rear vision assembly, subject to the driving signal;
wherein the driving signal is adapted for directing the motor to adjust the rear vision assembly to the default relative position and the default orientation when the determined first relative position has deviated from the default relative position for a predefined time and the sensed orientation deviates from the default orientation.

2. The system of claim 1, wherein the control device has a storage module for recording the default relative position of the rear vision assembly and the sending device, and the default orientation of the rear vision assembly in the three-dimensional space.

3. The system of claim 2, wherein the sending device is disposed at a wearable accessory, and when a directional indicator of the vehicle is actuated, the determined first relative position has not deviated from the default relative position for the predefined time, and the sensed orientation deviates from the default orientation, the control device is further adapted for generating the driving signal based on the direction indicated by the directional indicator.

4. The system of claim 2, wherein the sending device is disposed at the vehicle, and when a directional indicator of the vehicle is actuated and the sensed orientation deviates from the default orientation, the control device is further adapted for generating the driving signal based on the direction indicated by the directional indicator.

5. The system of claim 1, wherein the control device generates the driving signal based on a condition, the condition being that the rear vision assembly and the sending device have a second relative position.

6. A method for controlling a rear vision assembly of a vehicle, comprising:
receiving a reference signal from a sending device to generate a relative positioning signal;
determining a first relative position of the rear vision assembly and the sending device based on the relative positioning signal;
sensing an orientation of the rear vision assembly in the three-dimensional space; and
adjusting the rear vision assembly to a default relative position and a default orientation when the determined first relative position has deviated from the default relative position for a predefined time and the sensed orientation deviates from the default orientation.

7. The method of claim 6, further comprising recording the default relative position of the rear vision assembly and the sending device, and the default orientation of the rear vision assembly in the three-dimensional space.

8. The method of claim 7, wherein the sending device is disposed at a wearable accessory, and when a directional indicator of the vehicle is actuated, the determined first relative position has not deviated from the default relative position for the predefined time, and the sensed orientation deviates from the default orientation, the rear vision assembly is adjusted based on the direction indicated by the directional indicator.

9. The method of claim 7, wherein the sending device is disposed at the vehicle, and when a directional indicator of the vehicle is actuated and the sensed orientation deviates from the default orientation, the rear vision assembly is adjusted based on the direction indicated by the directional indicator.

10. The method of claim 6, wherein adjusting the rear vision assembly to the default relative position and the default orientation is based on a condition, the condition being that the rear vision assembly and the sending device have a second relative position.
